(19) United States
(12) Patent Application Publication
(10) Pub. No.: US 2012/0039167 A1
(43) Pub. Date: Feb. 16, 2012

(54) SYSTEM, APPARATUS, AND METHOD FOR IMPROVING REDIAL PERFORMANCE IN WIRELESS COMMUNICATION SYSTEMS

(75) Inventors: Arvind Swaminathan, San Diego, CA (US); Nitin Pant, San Diego, CA (US); Uttam Pattanayak, Hyderabad (IN); Raju Kasaramoni, Hyderabad (IN)

(73) Assignee: QUALCOMM Incorporated, San Diego, CA (US)

(21) Appl. No.: 13/205,495

(22) Filed: Aug. 8, 2011

Related U.S. Application Data
(60) Provisional application No. 61/372,355, filed on Aug. 10, 2010.

(51) Int. Cl. H04W 76/00; H04W 40/00; H04L 12/26

(52) U.S. Cl. 370/225

(57) ABSTRACT

In accordance with aspects of the disclosure, a method, apparatus, and computer program product are provided for wireless communication. The method, apparatus, and computer program product may be configured to acquire a first wireless network for data packet communication on a first radio access technology, request service for a voice call from a second radio access technology via a data tunnel provided by the first radio access technology, determine a failure in obtaining the requested service for the voice call, attempt to re-acquire the first radio access technology and redial the voice call via the first radio access technology in response to determining the failure, obtain the requested service for the voice call if performing of the attempt was less than or equal to a threshold, and acquire a second wireless network via the second radio access technology if performing of the attempt was greater than the threshold.

### CROSS-REFERENCE TO RELATED APPLICATIONS)

This application claims priority to and the benefit of U.S. Provisional Application Ser. No. 61/372,355, entitled, “Techniques to Optimize Silent Redial during 1xCSFB,” filed on Aug. 10, 2010, which is expressly incorporated herein by reference in its entirety.

### BACKGROUND

1. Field

The present disclosure relates generally to communication and, more specifically, to techniques for improving redial performance in wireless communication systems.

2. Background

Wireless communication systems are widely deployed to provide various telecommunication services including voice, telephony, video, data, messaging, and broadcasts. Some conventional wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, time division synchronous code division multiple access (TD-SCDMA) systems, and worldwide interoperability for microwave access (WiMAX).

For wireless communication systems, these multiple-access technologies have been adopted in various telecommunication standards to provide a common protocol that enables different wireless devices to communicate on a municipal, national, regional, and global level. These wireless multiple-access communication systems may simultaneously support communication for multiple wireless terminals. Each terminal communicates with one or more base stations via signal transmissions on a forward link and reverse link. The forward link or downlink (DL) refers to a communication link from the base stations to the terminals, and the reverse link or uplink (UL) refers to a communication link from the terminals to the base stations. Communication links may be established via a single-in-single-out, multiple-in-signal-out, or a multiple-in-multiple-out (MIMO) system.

Universal Mobile Telecommunications System (UMTS) is one of the third-generation (3G) cell phone technologies. UTRAN (UMTS Terrestrial Radio Access Network) is a term for referring to Node-B and Radio Network Controllers (RNCs) in a UMTS radio access network that may carry many different traffic types from real-time Circuit Switched (CS) to Internet Protocol (IP) based Packet Switched (PS). UTRAN provides connectivity between a UE (User Equipment) and a core network. UTRAN comprises base stations, which may be referred to as Node B devices and RNC devices. The RNC devices provide control functionalities for one or more Node B devices. The Node B and the RNC may be the same device, although typical implementations have a separate RNC located in a central office serving multiple Node B devices. The RNC and its corresponding Node Bs may be referred to as the Radio Network Subsystem (RNS). There may be more than one RNS present in an UTRAN.

CDMA2000 (also known as IMT Multi Carrier (IMT MC)) is a family of 3G mobile technology standards, which use CDMA channel access, to send voice, data, and signaling data between mobile phones and cell sites. The set of standards includes: CDMA2000 1x, CDMA2000 EV-DO Rev. 0, CDMA2000 EV-DO Rev. A, and CDMA2000 EV-DO Rev. B. All are approved radio interfaces for the ITU's IMT-2000. CDMA2000 has a relatively long technical history and is backward-compatible with its previous 2G iteration IS-95 (cdmaOne).

CDMA2000 1x (IS-2000), also known as 1x and 1xRTT, is the core CDMA2000 wireless air interface standard. The designation “1x”, meaning 1 times Radio Transmission Technology, indicates the same RF bandwidth as IS-95: a duplex pair of 1.25 MHz radio channels. 1xRTT almost doubles the capacity of IS-95 by adding 64 more traffic channels to the forward link, orthogonal to (in quadrature with) the original set of 64. The 1X standard supports packet data speeds of up to 153 kbps with real world data transmission averaging 60-100 kbps in most commercial applications. IMT-2000 also made changes to the data link layer for the greater use of data services, including medium and link access control protocols and Quality of Service (QoS). The IS-95 data link layer only provided “best effort delivery” for data and circuit switched channel for voice (i.e., a voice frame once every 20 ms).

CDMA2000 1xEV-DO (Evolution-Data Optimized), often abbreviated as EV-DO or EV, is a telecommunications standard for the wireless transmission of data through radio signals, typically for broadband Internet access. It uses multiplexing techniques including code division multiple access (CDMA) as well as time division multiple access (TDMA) to maximize both individual user's throughput and the overall system throughput. It is standardized by Third Generation Partnership Project 2 (3GPP2) as part of the CDMA2000 family of standards and has been adopted by many mobile phone service providers around the world, particularly those previously employing CDMA networks.

An example of an emerging telecommunication standard is Long Term Evolution (LTE). The LTE system is described in the Evolved UTRA (EUTRA) and Evolved UTRAN (EUTRAN) series of specifications. LTE provides a set of enhancements to the UMTS mobile standard promulgated by 3GPP. LTE is designed to better support mobile broadband Internet access by improving spectral efficiency, lower costs, improve services, make use of new spectrum, and better integrate with other open standards utilizing OFDMA on the downlink (DL), SC-FDMA on the uplink (UL), and multiple-input multiple-output (MIMO) antenna technology.

However, as the demand for mobile broadband access continues to increase, there exists a need for further improvements in LTE technology. Preferably, these improvements should be applicable to other multi-access technologies and the telecommunication standards that employ these technologies.

### SUMMARY

In accordance with an aspect of the disclosure, a method for wireless communication comprises acquiring a first wireless network for data packet communication on a first radio access technology, requesting service for a voice call from a second radio access technology via a data tunnel provided by the first radio access technology, wherein completing acquisition of the requested service is subject to a default threshold, determining a failure in obtaining the requested service for the voice call, attempting to re-acquire the first radio access technology and redial the voice call via the first radio access technology in response to determining the failure, wherein the attempt is performed for less than or equal to a first threshold that is less than the default threshold, obtaining the requested service for the voice call if performing of the attempt was less than or equal to the first threshold, and acquiring a second wireless network via the second radio access technology if performing of the attempt was greater than the first threshold.

In accordance with an aspect of the disclosure, an apparatus for wireless communication comprises a processing system configured to acquire a first wireless network for data packet communication on a first radio access technology, request service for a voice call from a second radio access technology via a data tunnel provided by the first radio access technology, wherein completing acquisition of the requested service is subject to a default threshold, determine a failure in obtaining the requested service for the voice call, attempt to re-acquire the first radio access technology and redial the voice call via the first radio access technology in response to determining the failure, wherein the attempt is performed for less than or equal to a first threshold that is less than the default threshold, obtain the requested service for the voice call if performing of the attempt was less than or equal to the first threshold, and acquire a second wireless network via the second radio access technology if performing of the attempt was greater than the first threshold.

In accordance with an aspect of the disclosure, an apparatus for wireless communication comprises means for acquiring a first wireless network for data packet communication on a first radio access technology, means for requesting service for a voice call from a second radio access technology via a data tunnel provided by the first radio access technology, wherein completing acquisition of the requested service is subject to a default threshold, means for determining a failure in obtaining the requested service for the voice call, means for attempting to re-acquire the first radio access technology and redial the voice call via the first radio access technology in response to determining the failure, wherein the attempt is performed for less than or equal to a first threshold that is less than the default threshold, means for obtaining the requested service for the voice call if performing of the attempt was less than or equal to the first threshold, and means for acquiring a second wireless network via the second radio access technology if performing of the attempt was greater than the first threshold.

In accordance with an aspect of the disclosure, a computer program product comprises a computer-readable medium comprising code executable to cause an apparatus to acquire a first wireless network for data packet communication on a first radio access technology, request service for a voice call from a second radio access technology via a data tunnel provided by the first radio access technology, wherein completing acquisition of the requested service is subject to a default threshold, determine a failure in obtaining the requested service for the voice call, attempt to re-acquire the first radio access technology and redial the voice call via the first radio access technology in response to determining the failure, wherein the attempt is performed for less than or equal to a first threshold that is less than the default threshold, obtain the requested service for the voice call if performing of the attempt was less than or equal to the first threshold, and acquire a second wireless network via the second radio access technology if performing of the attempt was greater than the first threshold.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows a diagram illustrating an embodiment of a wireless communication network, in accordance with aspects of the disclosure.

FIG. 2 shows a diagram illustrating an embodiment of an access network, in accordance with aspects of the disclosure.

FIG. 3 shows a diagram illustrating an embodiment of a multiple access wireless communication system, in accordance with aspects of the disclosure.

FIG. 4 shows a diagram illustrating an embodiment of a communication network for circuit switched fall back (CSFB), in accordance with aspects of the disclosure.

FIG. 5 shows a diagram illustrating an embodiment of a multiple input multiple output (MIMO) communication system, in accordance with aspects of the disclosure.

FIG. 6 shows a diagram illustrating an embodiment of a methodology for optimizing silent redial during 1xCSFB, in accordance with aspects of the disclosure.

FIG. 7 shows a diagram illustrating an embodiment of a methodology for optimizing cell selection scan after radio link failure (RLF) during 1xCSFB, in accordance with aspects of the disclosure.

FIG. 8 shows a diagram illustrating an example architecture of a wireless communication device, in accordance with aspects of the disclosure.

FIG. 9 shows a diagram illustrating an embodiment of a process flow for a method of improving redial performance in wireless communication systems, in accordance with aspects of the disclosure.

FIG. 10 shows a diagram illustrating an embodiment of functionality of an apparatus configured to facilitate wireless communication, in accordance with aspects of the disclosure.

### DETAILED DESCRIPTION

The detailed description set forth below in connection with the appended drawings is intended as a description of various configurations and is not intended to represent the only configurations, in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in diagram form to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented utilizing electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices. (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. In accordance with aspects of the disclosure, the computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

The techniques described herein may be utilized for various wireless communication networks such as Code Division Multiple Access (CDMA) networks, Time Division Multiple. Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often utilized interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is utilized in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

In an aspect of the disclosure, a wireless multiple-access communication system is configured to simultaneously support communication for multiple wireless terminals. Each terminal communicates with one or more base stations via transmissions on the forward and reverse links. The forward link or DL refers to the communication link from the base stations to the terminals, and the reverse link or UL refers to the communication link from the terminals to the base stations. This communication link may be established via a single-in-single-out, multiple-in-single-out, or a multiple-in-multiple-out (MIMO) system.

In an aspect of the disclosure, a MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S} min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

In an aspect of the disclosure, a MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

In accordance with aspects of the disclosure, it should be appreciated that the initial LTE deployments may not support voice natively over LTE. This is because it will take time to deploy IP Multimedia Subsystem (IMS) and fine-tune Voice over IP (VoIP) performance over LTE. An option for delivering voice services in initial LTE deployments is 1x Circuit Switched Fallback (1xCSFB). The basic idea is for User Equipment (UE) to switch to 1x while taking part in a voice call. After the call completes the UE will return to LTE, if available. The presence of a S102 tunnel (between LTE and 1x networks) allows the UE to remain registered with the 1x network while on LTE. The 1x network delivers pages to the UE through the tunnel. In e1xCSFB (enhanced 1x Circuit Switched Fallback), when the UE has to move to 1x to take part in either a Mobile Terminated (MT) or Mobile Originated (MO) voice call, the UE, LTE network and the 1x network exchange messages to create a 1x traffic channel for the UE to handover into.

In an aspect of the disclosure, when the user places a call while on LTE, the UE begins an Extended Service Request (ESR) procedure. One or more failures may occur during the ESR procedure. For instance, when a failure happens, the UE performs a silent redial procedure for 30 to 60 seconds after the call was first initiated. As part of the silent redial procedure, the UE may either retry the call on LTE or move to a 1x system to place the call. In an implementation, failures may be mapped to hard failures (i.e., silent redial on 1x) or soft failures (i.e., silent redial on LTE). Accordingly, optimizations may then be implemented to handle radio link failure (RLF) during the ESR procedure.

In accordance with aspects of the disclosure, mapping of failures to silent redial target Radio Access Technology (RAT) addresses factors to determine whether the silent redial should be performed over the LTE domain or over the native 1x domain. For example, one factor may be which domain will lead to lower call setup delay. Another factor may be which domain will lead to the highest call success probability. For instance, if the subsequent attempt on LTE is successful, the call set up delay would be of the order of 1 second. If the subsequent attempt is made on 1x and acquisition on the first 1x channel succeeds, the call set up delay will be of the order of 4 seconds. Since the call set up delay on LTE is much lower, retrying on LTE after a failure may generally be recommended when there is reasonable probability of success on LTE during the retry.

In accordance with aspects of the disclosure, completing a voice call following a radio link failure (RLF) (i.e., a soft failure) is optimized by re-acquiring a first wide-area wireless access network (WWAN) that was previously used for data packet communication on a first Radio Access Technology (RAT) (e.g., LTE). In particular, the attempt to complete Enhanced Service Request (ESR) procedure to a second WWAN for a second RAT (e.g., 1xRTT) via LTE is performed in a limited technique based upon a re-try counter and timer. Moreover, a re-scan for re-acquisition after RLF is performed solely on band used by LTE for Private Land Mobile Network (PLMN) without scanning other RATs (e.g., GSM). The scan may be limited by the network, User Equipment (UE) or both. Without wasting too much time, then the re-dial for the voice call may be performed by acquiring a second WWAN for the second RAT (e.g., 1xRTT) if unable to promptly complete ESR.

Aspects of the disclosure are described in connection with optimizing an extended service request following a failure, such as a radio link failure. For instance, a method is provided for completing a voice call following a radio link failure. In one implementation, User Equipment (UE) may be configured to acquire a first wide-area wireless access network for data packet communication on a first radio access technology (RAT), such as LTE. The UE may be configured to request service for a mobile-originated (MO) or mobile terminated (MT) voice call from a second RAT, such as 1xRTT (First Version Radio Transmission Technology) via a data tunnel provided by the first RAT. Completing acquisition of the requested service may be subject to a default threshold. The UE may be configured to determine a failure in obtaining the requested service. The UE may be configured to perform a limited attempt (e.g., scan LTE bands once) to re-acquire the first RAT and to redial the voice call via the first RAT in response to determining of the failure. Performing the limited attempt may comprise performing for less than or equal to a first threshold that is less than the default threshold. The UE may be configured to obtain the service via the limited attempt if the performing of the limited attempt was less than or equal to the first threshold. The UE may be configured to acquire a second wide-area wireless access network via the second RAT if the performing of the limited attempt was greater than the first threshold.

Various aspects of the disclosure are described herein in connection with a mobile device. In some aspects, the mobile device may also be referred to as a system, a subscriber unit, a subscriber station, mobile station, mobile, mobile device, cellular device, multi-mode device, remote station, remote terminal, access terminal, user terminal, user agent, a user device, or user equipment, or the like. A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

Various aspects of the disclosure are described with reference to the drawings. In the following description, for purposes of explanation, numerous specific details are set forth to provide a thorough understanding of one or more aspects. It may be evident, however, that the various aspects may be practiced without these specific details. In other instances, well-known structures and devices are shown in diagram form to facilitate describing these aspects.

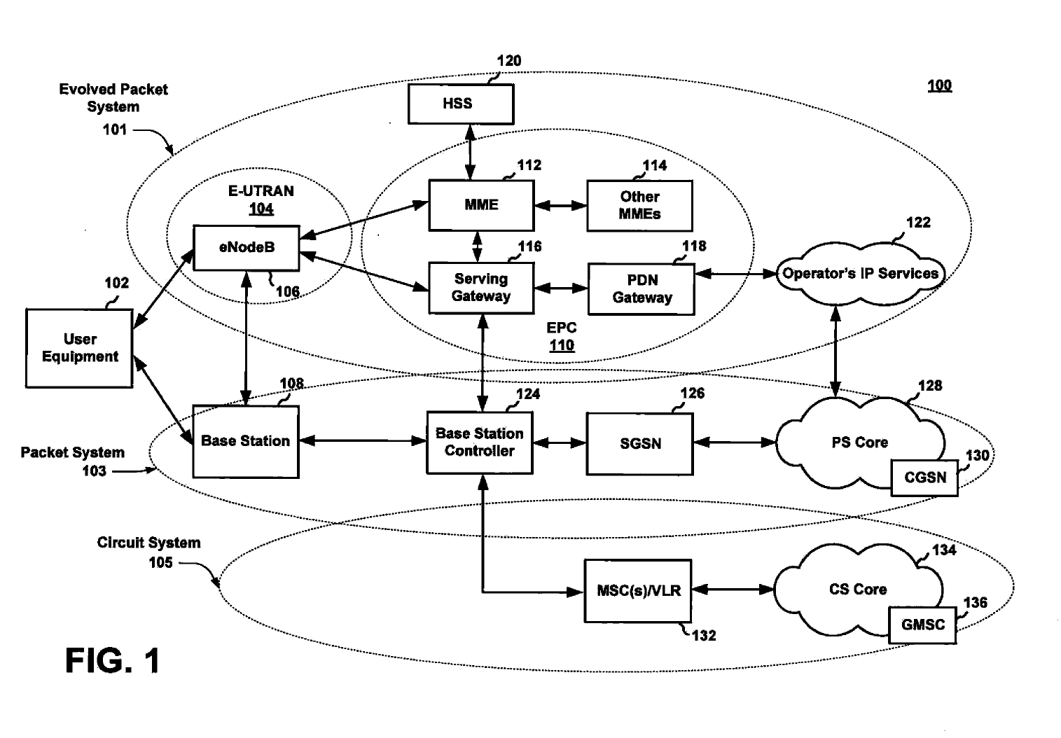

FIG. 1 is a diagram illustrating an embodiment of a wireless network architecture 100 employing various apparatuses, in accordance with aspects of the disclosure. Referring to FIG. 1, the network architecture 100 may include an Evolved Packet System (EPS) 101. The EPS 101 may include one or more UE 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS may interconnect with other access networks, such as a packet switched core (PS core) 128, a circuit switched core (CS core) 134, etc. As shown, the EPS provides packet-switched services, however, as those skilled in the art will readily appreciate, the various concepts presented throughout this disclosure may be extended to networks providing circuit-switched services, such as the network associated with CS core 134.

The network architecture 100 may further include a packet switched network 103 and a circuit switched network 105. In an implementation, the packet switched network 103 may include base station 108, base station controller 124, Serving GPRS Support Node (SGSN) 126, PS core 128 and Combined GPRS Service Node (CGSN) 130. In another implementation, the circuit switched network 105 may include base station 108, base station controller 124, MSC, Visitor location register (VLR) 132, CS core 134 and Gateway Mobile Switching Centre (GMSC) 136.

The E-UTRAN 104 may include an evolved Node B (eNB) 106 and connection to other networks, such as packet and circuit switched networks may be facilitated through base station 108. The eNB 106 provides user and control plane protocol terminations toward the UE 102. The eNB 106 may be connected to the other eNBs 108 via an X2 interface (i.e., backhaul). The eNB 106 may also be referred to by those skilled in the art as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 include the Internet, the Intranet, an IP Multimedia Subsystem (IMS), and a PS Streaming Service (PSS).

In an aspect of the disclosure, the wireless system 100 may be enabled to facilitate CS fallback (CSFB). As used herein, CSFB may refer to establishing a signaling channel between a circuit switched MSC 132 and the LTE core network 110 to allow for services, such as voice calls, short message service (SMS), etc. In such an aspect, CSFB may be enabled when a UE 102 is associated with EPS 101 (e.g., camped on the LTE network 101) and registered to receive pages for mobile terminated (MT) calls on the LTE network 101. In operation, the UE 102 may receive a page on the LTE network 101. Thereafter, the UE 102 may be transitioned by the LTE network 101 to a CS based cell 108 (e.g., a UTRAN cell, GERAN cell, etc.) to perform CS call setup. In an implementation, CS call setup may be performed using a page response message. As implemented through a LTE network 101, CSFB may be different from legacy CS call set up on native CS based cells 108 (e.g., UTRAN/GERAN) in that the UE 102 may receive a page for an MT call on one cell and may respond to the page on another cell.

Generally, while camped on the LTE network 101, a CSFB capable UE 102 may be attached to a 3GPP MSC 132. This 3GPP MSC 132 may serve a first location area, e.g., LA1. In an aspect, MT CSFB call processing may involve the UE being moved from the LTE network 101, where a page was received, to CS based cell 108 (e.g., a UTRAN cell, GERAN cell, etc.) where a page response may be sent.

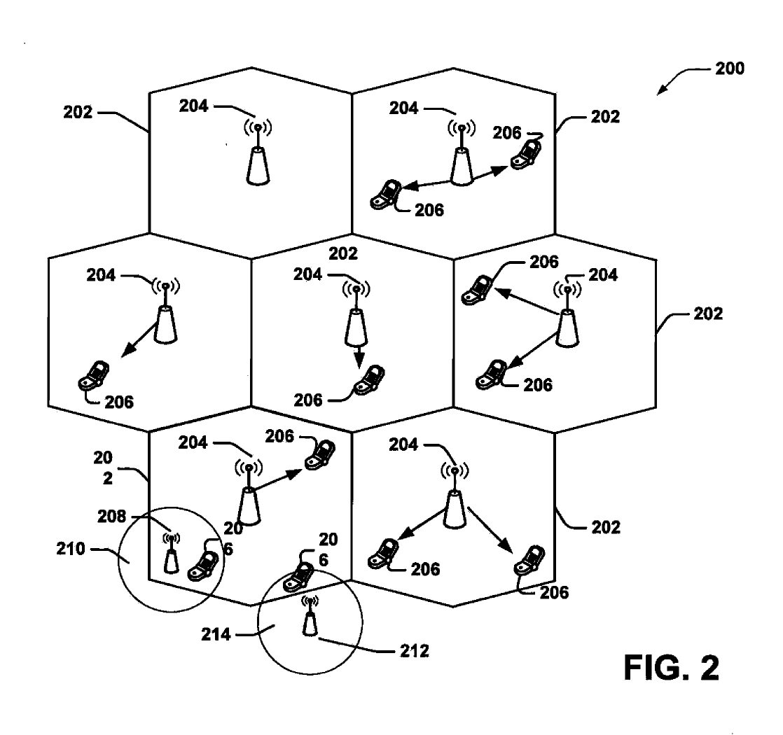

FIG. 2 is a diagram illustrating an embodiment of an access network in an LTE network architecture, in accordance with aspects of the disclosure. In this example, the access network 200 is divided into a number of cellular regions (cells) 202. One or more lower power class eNBs 208, 212 may have cellular regions 210, 214, respectively, that overlap with one or more of the cells 202. The lower power class eNBs 208, 212 may be femto cells (e.g., home eNBs (HeNBs)), pico cells, or micro cells. A higher power class or macro eNB 204 is assigned to a cell 202 and is configured to provide an access point to the EPC 110 for all the UEs 206 in the cell 202. There is no centralized controller in this example of an access network 200, but a centralized controller may be used in alternative configurations. The eNB 204 is responsible for all radio related functions including radio bearer control, admission control, mobility control, scheduling, security, and connectivity to the serving gateway 216 (e.g., see FIG. 1).

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 2nd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS; LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

In an aspect of the disclosure, the eNB 204 may have multiple antennas supporting MIMO technology. It should be appreciated that the utilization of MIMO technology enables the eNB 204 to exploit the spatial domain to support spatial multiplexing, beamforming, and transmit diversity.

In an aspect of the disclosure, spatial multiplexing may be used to transmit different streams of data simultaneously on the same frequency. The data steams may be transmitted to a single UE 206 to increase the data rate or to multiple UEs 206 to increase the overall system capacity. This may be achieved by spatially precoding each data stream and then transmitting each spatially precoded stream through a different transmit antenna on the downlink. The spatially precoded data streams arrive at the UE(s) 206 with different spatial signatures, which enables each of the UE(s) 226 to recover the one or more data streams destined for that UE 206. On the uplink, each UE 206 transmits a spatially precoded data stream, which enables the eNB 204 to identify the source of each spatially precoded data stream.

In an aspect of the disclosure, spatial multiplexing may be used when channel conditions are good. When channel conditions are less favorable, beamforming may be used to focus the transmission energy in one or more directions. This may be achieved by spatially precoding the data for transmission through multiple antennas. To achieve good coverage at edges of the cell, a single stream beamforming transmission may be used in combination with transmit diversity.

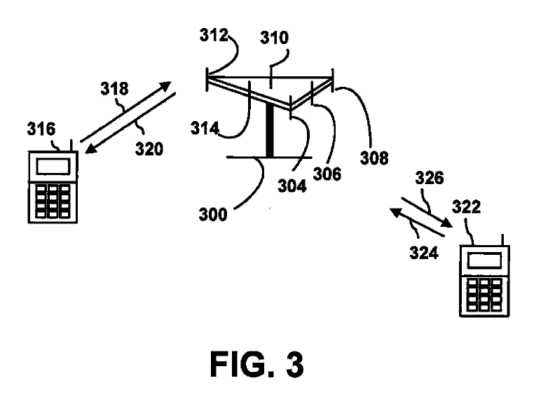

FIG. 3 shows a diagram illustrating an embodiment of a multiple access wireless communication system, in accordance with aspects of the disclosure. Referring to FIG. 3, an access point (AP) 300 includes multiple antenna groups, one including 304 and 306, another including 308 and 310, and an additional including 312 and 314. In FIG. 3, only two antennas are shown for each antenna group, however, more or fewer antennas may be utilized for each antenna group. Access terminal (AT) 316 is in communication with antennas 312 and 314, where antennas 312 and 314 transmit information to access terminal 316 over forward link 320 and receive information from access terminal 316 over reverse link 318. Access terminal 322 is in communication with antennas 306 and 308, where antennas 306 and 308 transmit information to access terminal 322 over forward link 326 and receive information from access terminal 322 over reverse link 324. In a FDD system, communication links 318, 320, 324 and 326 may use different frequencies for communication. For example, forward link 320 may use a different frequency then that used by reverse link 318.

In an aspect of the disclosure, each group of antennas and/or the area in which they are designed to communicate is often referred to as a sector of the access point. In the aspect, antenna groups each are designed to communicate to access terminals in a sector, of the areas covered by access point 300.

In communication over forward links 320 and 326, the transmitting antennas of access point 300 utilize beamforming to improve the signal-to-noise ratio of forward links for the different access terminals 316 and 322. Also, an access point using beamforming to transmit to access terminals scattered randomly through its coverage causes less interference to access terminals in neighboring cells than an access point transmitting through a single antenna to all of its access terminals.

An access point may be a fixed station used for communicating with the terminals and may also be referred to as an access point, a Node B, or some other terminology. An access terminal may also be called user equipment (UE), a wireless communication device, terminal, or some other terminology.

In an aspect of the disclosure, a MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

In an aspect of the disclosure, a MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

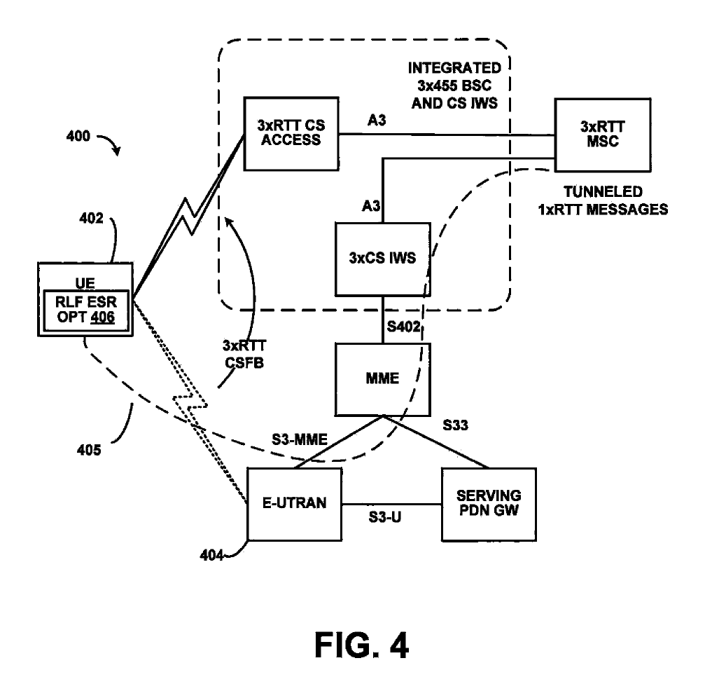

FIG. 4 shows a diagram illustrating an embodiment of a communication network for circuit switched fall back (CSFB), in accordance with aspects of the disclosure. Referring to FIG. 4, a wireless communication system 400 performs reliable Inter-RAT core network interactions. For example, an enhanced First Version Circuit Switch Fallback (e1xCSFB) procedure is provided. 1xCSFB provides a mechanism to support 1x circuit services while UE 402 camps on E-UTRAN 404. Recently, the enhanced (e) 1xCSFB procedure was approved for Release 9 in 3GPP. e1xCSFB is designed based on a traffic channel assignment procedure through a tunnel 405 developed for Single Radio Voice Call Continuity (SRVCC). For instance, in particular, the UE 402 executes Radio Link Failure (RLF) Extended Service Request (ESR) optimization components 406 to perform aspects of the present disclosure as described herein.

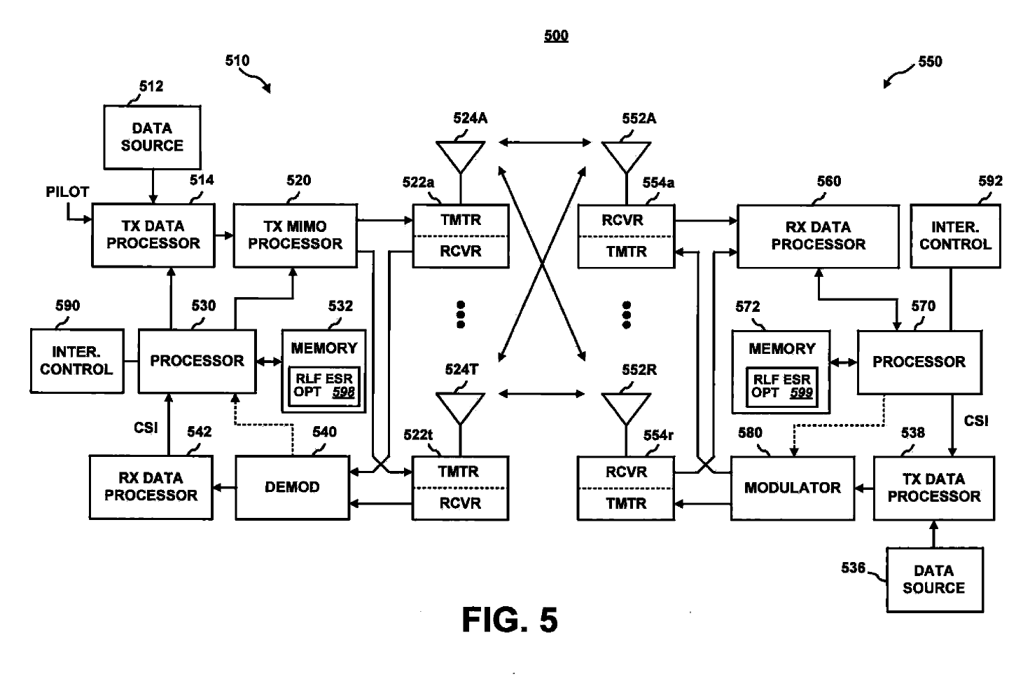

FIG. 5 shows a diagram illustrating an embodiment of a multiple input multiple output (MIMO) communication system, in accordance with aspects of the disclosure. The teachings herein may be incorporated into a node (e.g., a device) employing various components for communicating with at least one other node. FIG. 5 depicts several sample components that may be employed to facilitate communication between nodes. For instance, FIG. 5 illustrates a wireless device 510 (e.g., an access point) and a wireless device 550 (e.g., an access terminal) of a MIMO system 500. At the device 510, traffic data for a number of data streams is provided from a data source 512 to a transmit (“TX”) data processor 514.

In some aspects, each data stream is transmitted over a respective transmit antenna. The TX data processor 514 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 530. A data memory 532 may store program code, data, and other information used by the processor 530 or other components of the device 510.

The modulation symbols, for all data streams are then provided to a TX MIMO processor 520, which may further process the modulation symbols (e.g., for OFDM). The TX MIMO processor 520 then provides N_{T} modulation symbol streams to N_{T} transceivers (“XCVR”) 522a through 522t that each has a transmitter (TMTR) and receiver (RCVR). In some aspects, the TX MIMO processor 520 applies beam-forming weights to the symbols of the data streams and to the antenna from which the symbol is being transmitted.

Each transceiver 522a-522t receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 522a through 522t are then transmitted from N_{T} antennas 524a through 524t, respectively.

At the device 550, the transmitted modulated signals are received by N_{R} antennas 552a through 552r and the received signal from each antenna 552a-552r is provided to a respective transceiver (“XCVR”) 554a through 554r. Each transceiver 554a-554r conditions (e.g., filters, amplifies, and downconverts) a respective received signal, digitizes the conditioned signal to provide samples, and further processes the samples to provide a corresponding “received” symbol stream.

In an aspect of the disclosure, a receive (“RX”) data processor 560 then receives and processes the N_{R} received symbol streams from N_{R} transceivers 554a-554r based on a particular receiver processing technique to provide N_{T} “detected” symbol streams. The RX data processor 560 then demodulates, deinterleaves, and decodes each detected symbol stream to recover the traffic data for the data stream. The processing by the RX data processor 560 is complementary to that performed by the TX MIMO processor 520 and the TX data processor 514 at the device 510.

In an aspect of the disclosure, a processor 570 periodically determines which pre-coding matrix to use. The processor 570 formulates a reverse link message comprising a matrix index portion and a rank value portion. A data memory 572 may store program code, data, and other information used by the processor 570 or other components of the device 550.

In an aspect of the disclosure, the reverse link message may comprise various types of information regarding the communication link and/or the received data stream. The reverse link message is then processed by a TX data processor 538, which also receives traffic data for a number of data streams from a data source 536, modulated by a modulator 580, conditioned by the transceivers 554a through 554r, and transmitted back to the device 510.

At device 510, the modulated signals from the device 550 are received by the antennas 524a-524t, conditioned by the transceivers 522a-522t, demodulated by a demodulator (“DEMOD”) 540, and processed by a RX data processor 542 to extract the reverse link message transmitted by the device 550. The processor 530 then determines which pre-coding matrix to use for determining the beam-forming weights then processes the extracted message.

FIG. 5 further illustrates that communication components may include one or more components that perform interference control operations. For example, an interference (“INTER.”) control component 590 may cooperate with the processor 530 and/or other components of the device 510 to send/receive signals to/from another device (e.g., device 550). Similarly, an interference control component 592 may cooperate with the processor 570 and/or other components of the device 550 to send/receive signals to/from another device (e.g., device 510). In accordance with aspects of the disclosure, it should be appreciated that for each device 510 and 550 the functionality of two or more of the described components may be provided by a single component. For example, a single processing component may provide the functionality of the interference control component 590 and the processor 530 and a single processing component may provide the functionality of the interference control component 592 and the processor 570.

In an aspect of the disclosure, memories 532, 572 may respectively store Radio Link Failure (RLF) Extended Service Request (ESR) optimization components 598, 599 to implement aspects described herein.

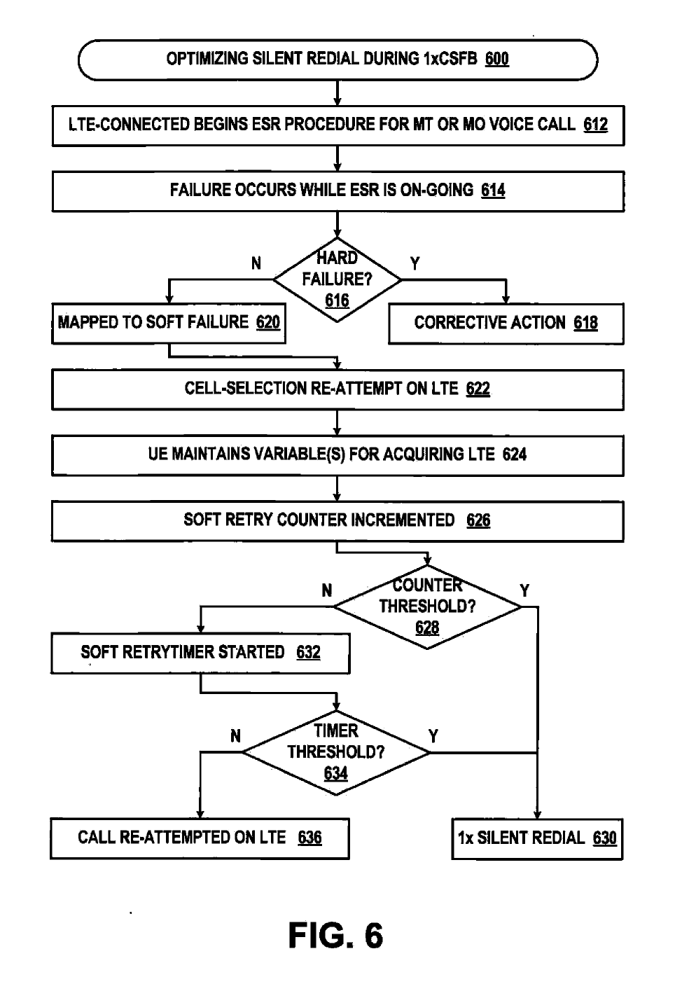

FIG. 6 shows a diagram illustrating an embodiment of a methodology for optimizing silent redial during 1xCSFB, in accordance with aspects of the disclosure.

Referring to FIG. 6, the methodology for optimizing silent redial during 1xCSFB begins in 600. In 610, a UE that is connected to an LTE RAT for data packet communication begins an Enhanced Service Request (ESR) procedure for a mobile termination (MT) or mobile originated (MO) voice call (612). While ESR is on-going, a failure may occur (614), and a determination may be made whether the failure is a hard failure (616). For instance, a hard failure may indicate a context mismatch between the UE and the LTE network. In another instance, IWS (1xCS Interworking Solution) may not be functioning correctly. In another instance, LTE access may be barred. In another instance, the LTE connection may be established only after a delay, etc. With the failure mapped to one of these hard failures, an appropriate corrective action may be taken (618). However, if a hard failure is not determined in 616, then the failure may be mapped to a soft failure (620). Soft failures may arise during ESR due to Radio Link Failure (RLF).

During the ESR procedure, inter-eNB (evolved Base Node) handovers may be prevented by the network. This is because the 1xCSFB related context may not be transferred if the UE moves from one eNB to another in the middle of the procedure. Hence, if the UE moves to the boundary of an eNB during the ESR procedure, the call may fail due to a Radio Link Failure (RLF).

After the RLF, the UE may re-attempt cell-selection on LTE (622). Given a shorter acquisition time typical of acquiring LTE as compared to 1x, attempting this reacquisition may reduce the delay. During a cell-selection procedure, the UE may acquire the same eNB or another eNB if it is still within LTE coverage. If the UE acquires an eNB as part of this cell selection phase, there is a reasonable chance that the ESR procedure may succeed on the retry. Hence, if RLF happens during the ESR procedure, the UE may attempt to re-acquire LTE during the cell-selection phase as a first preference.

In an aspect of the disclosure, to limit the amount of time spent retrying the call over LTE, the UE may maintain one or more variables representative of an effort to acquire an LTE service (624). For instance, the UE may maintain at least two variables. First, a soft retry counter may be incremented when a soft failure occurs during the e1xCSFB procedure (626). The amount by which the counter is incremented may depend upon the type of failure. If the soft retry counter reaches a first threshold (e.g., a number of retry attempts, such as N_min_MO_call_soft_retry) (628), then the UE may leave LTE and move to 1x as part of silent redial (630).

In another instance, if the counter has not reached the first threshold in 628, then a soft retry timer may be started when the UE starts the MO/MT ESR procedure on LIE (632). If the time exceeds a second threshold (e.g., a maximum time for retrying on LTE, such as a time>T_max_LTE_attempt) (634), the UE may leave LTE and move to 1x(630). Based on the retry counter and the retry timer, the call may be re-attempted on LTE (636).

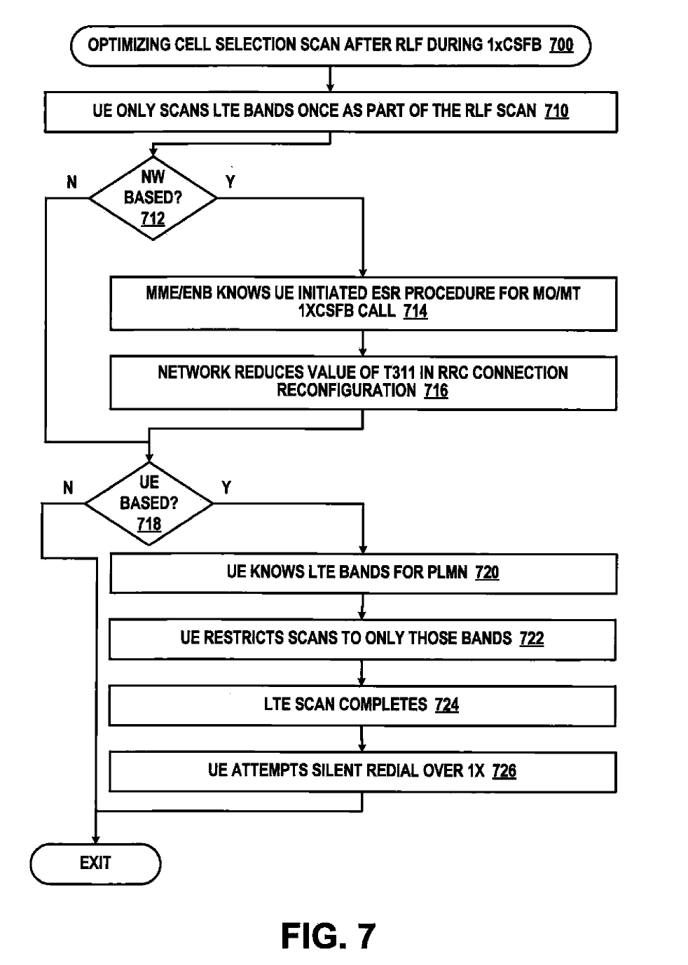

FIG. 7 shows a diagram illustrating an embodiment of a methodology for optimizing cell selection scan after radio link failure (RLF) during 1xCSFB, in accordance with aspects of the disclosure.

Referring to FIG. 7, a methodology for optimizing cell selection scan after RLF during 1xCSFB begins in 700. In an aspect of the disclosure, the time for which the UE performs cell selection (RLF scan) after RLF depends on the T311 timer signaled by the network as part of Radio Resource Control (RRC) connection reconfiguration message. During the RLF scan, if the UE supports UMTS and GSM, it will also scan these RATs after scanning LTE if the T311 timer has not expired.

To avoid undue delay, aspects of the disclosure provide that, during the 1xCSFB procedure, the UE only scans all of the LTE bands once as part of the RLF scan (710). Achieving this result may be achieved by a network-based approach, a UE-based approach, or by a collaboration of both the network and UE.

In an aspect of the disclosure, a network-based solution restricts scans during RLF (712). The Mobility Management Entity (MME)/eNB know when the UE has initiated an ESR procedure for a MO/MT 1xCSFB call (714). Hence, the network may reduce the value of T311 it signals to the UE that has initiated a 1xCSFB procedure in the RRC Connection reconfiguration message it sends to the UE (716). The value may be only long enough to allow for a full band scan of the supported LTE bands.

In another implementation, a UE-based solution may restrict scans during RLF (718). If the UE knows the LTE bands on which the current Private Land Mobile Network (PLMN) is available (720), then the UE may restrict its scans to only those bands (722). The LTE bands on which a PLMN is available may be learned using the 3GPP-BST for instance.

Accordingly, the bands/RATs scanned in the RLF scan and the amount of time spent in RLF scan may be controlled by the UE. This UE based solution may be needed because the network may not adapt T311 based on whether the UE is in the middle of 1xCSFB procedure. Even if T311 is reduced, the UE may finish scanning all the LTE frequencies of interest within the allocated lower value of T311.

In an aspect of the disclosure, by virtue of the foregoing, if the UE is in the middle of the 1xCSFB procedure and RLF happens (and the soft retry count has not exceeded max value), then the UE may initiate an RLF scan. During the scan, the UE may only scan the LTE bands that include the same PLMN. The UE may not scan GSM/UMTS bands or wait for T311 to expire. After the LTE scan completes (724), the UE may attempt silent redial over 1x (726). Therefore, according to aspects of the disclosure, the UE restricts scans to LTE bands that include PLMN in the RLF scan during 1xCSFB procedure without waiting for T311 timer to expire or scanning other RATs supported in the UE before moving to 1x.

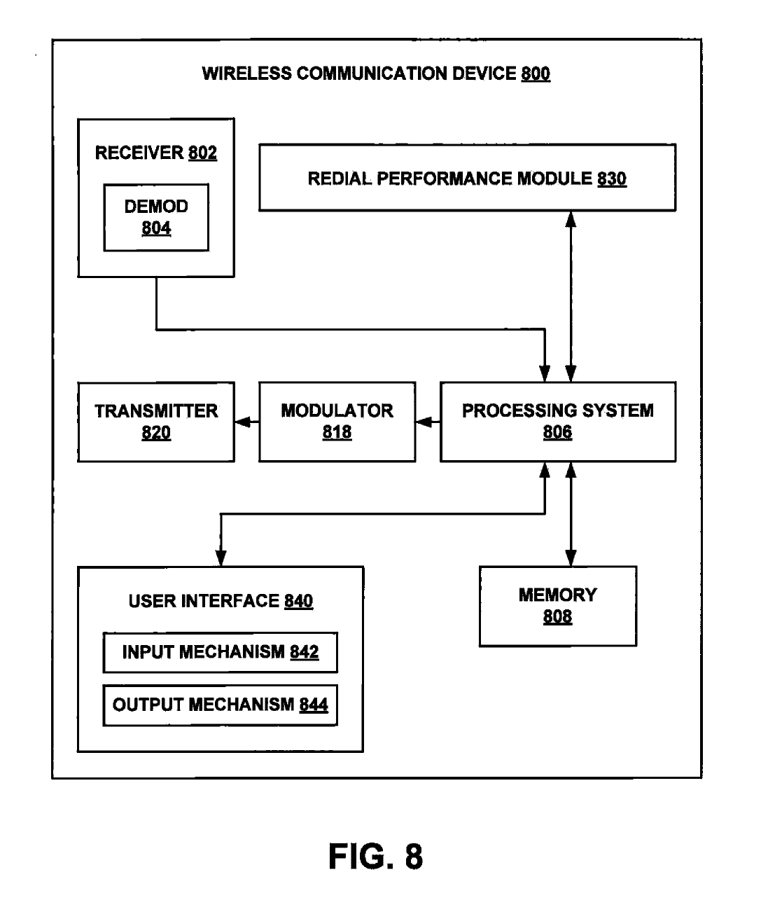

FIG. 8 shows a diagram illustrating an embodiment of a hardware implementation for an apparatus 800 employing a processing system 806 and a memory 808, in accordance with aspects of the disclosure. In various implementations, the apparatus 800 comprises an example of one or more of the wireless communication devices of FIG. 1. As shown in FIG. 8, the wireless communication device 800 comprises a receiver 802 that receives a signal from, for instance, a receive antenna (not shown), performs actions on (e.g., filters, amplifies, downconverts, etc.) the received signal, and digitizes the conditioned signal to obtain samples. The receiver 802 may comprise a demodulator 804 that may demodulate received symbols and provide them to the processing system 806 for channel estimation. The processing system 806 may comprise one or more processors configured for analyzing information received by the receiver 802 and/or for generating information for transmission by a transmitter 820. In an implementation, the processing system 806 may comprise one or more processors configured to control one or more components of the wireless communication device 800. In another implementation, the processing system 806 may comprise one or more processors configured to analyze information received by the receiver 802, generate information for transmission by the transmitter 820, and/or control one or more components of the wireless communication device 800.

In an aspect of the disclosure, the wireless communication device 800 comprises the memory 808 that is operatively coupled to the processor 806. The memory 808 may be configured to store data to be transmitted, received data, information related to available channels, data associated with analyzed signal and/or interference strength, information related to an assigned channel, power, rate, or the like, and any other suitable information for estimating a channel and communicating via the channel. The memory 808 may be configured to store protocols and/or algorithms associated with estimating and/or utilizing a channel (e.g., performance based, capacity based, etc.).

Further, the processor 806 may provide means for determining that a device is switching from a first location and a first cell to a circuit switched (CS) cell with a second location to implement a mobile terminated (MT) CS fallback (CSFB) process, means for generating a routing area (RA) update message including a flag indicating a pending data packet for communication, and means for transmitting the generated RA update message.

In various aspects of the disclosure, it should be appreciated that data store (e.g., memory 808) described herein may be either volatile memory or nonvolatile memory, or may include both volatile and nonvolatile memory. By way of illustration, and not limitation, nonvolatile memory may include read only memory (ROM), programmable ROM (PROM), electrically programmable ROM (EPROM), electrically erasable PROM (EEPROM), or flash memory. Volatile memory may include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 808 of the subject systems and methods may comprise, without being limited to, these and any other suitable types of memory.

In an implementation, the wireless communication device 800 may further include a redial performance module 830 configured to facilitate wireless communication in a network using multiple radio access technologies. The redial performance module 830 may be configured to acquire a first wireless network (e.g., a first wide-area access network) for data packet communication on a first radio access technology (e.g., LTE). The redial performance module 830 may be configured to request service for a voice call (e.g., MO voice call or MT voice call) from a second radio access technology (e.g., 1xRTT) via a data tunnel provided by the first radio access technology (e.g., LTE), wherein completing acquisition of the requested service is subject to a default threshold. The redial performance module 830 may be configured to determine a failure (e.g., a radio link failure) in obtaining the requested service for the voice call. The redial performance module 830 may be configured to attempt to re-acquire the first radio access technology (e.g., LTE) and redial the voice call via the first radio access technology (e.g., LTE) in response to determining the failure, wherein the attempt is performed for less than or equal to a first threshold that is less than the default threshold. The redial performance module 830 may be configured to obtain the requested service for the voice call if performing of the attempt was less than or equal to the first threshold. The redial performance module 830 may be configured to acquire a second wireless network (e.g., a second wide-area access network) via the second radio access technology (e.g., 1xRTT) if performing of the attempt was greater than the first threshold.

In an implementation, the redial performance module 830 may be configured to acquire the second wireless network via the second radio access technology in response to detecting the failure as a hard failure to communicate with the first wide-area wireless access network. In an example, detecting the hard failure may comprise detecting at least one of a context mismatch between user equipment and the first wireless network, an incorrectly functioning 1x circuit switched (CS) interworking solution, and access to the first radio access technology is barred by the first wireless network.

In an implementation, the wireless communication device 800 may include a user interface 840. The user interface 840 may include input mechanisms 842 for generating inputs into the wireless communication device 800, and an output mechanism 842 for generating information for consumption by the user of the wireless communication device 800. For example, the input mechanism 842 may include a mechanism, such as a key or keyboard, a mouse, a touch-screen display, a microphone, etc. In an example, the output mechanism 844 may include a display, an audio speaker, a haptic feedback mechanism, a Personal Area Network (PAN) transceiver etc. In the illustrated embodiments, the output mechanism 844 may include a display operable to present media content that is in image or video format or an audio speaker to present media content that is in an audio format.

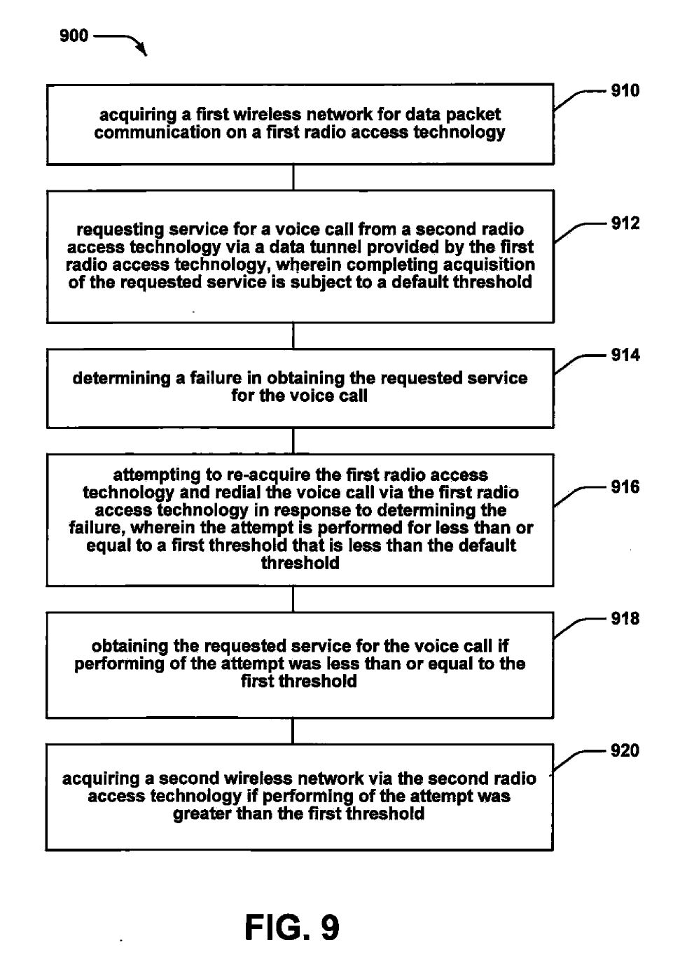

FIG. 9 shows a diagram 900 illustrating an embodiment of a process flow for a method of improving redial performance in wireless communication systems, in accordance with aspects of the disclosure.

Referring to FIG. 9, at 910, the method is configured for acquiring a first wireless network for data packet communication on a first radio access technology. At 912, the method is configured for requesting service for a voice call from a second radio access technology via a data tunnel provided by the first radio access technology, wherein completing acquisition of the requested service is subject to a default threshold. At 914, the method is configured for determining a failure in obtaining the requested service for the voice call. At 916, the method is configured for attempting to re-acquire the first radio access technology and redial the voice call via the first radio access technology in response to determining the failure, wherein the attempt is performed for less than or equal to a first threshold that is less than the default threshold. At 918, the method is configured for obtaining the requested service for the voice call if performing of the attempt was less than or equal to the first threshold. At 920, the method is configured for acquiring a second wireless network via the second radio access technology if performing of the attempt was greater than the first threshold.

In an implementation, the first wireless network may comprise a first wide-area access network, and the first radio access technology may comprise, for example, Long Term Evolution (LTE). The second wireless network may comprise a second wide-area access network, and the second radio access technology may comprise, for example, 1x Radio Transmission Technology (RTT). The voice call may comprise a mobile-originated voice call or mobile terminated voice call. The failure may comprise a radio link failure.

In an implementation, the method may further comprise acquiring the second wireless network via the second radio access technology in response to detecting the failure as a hard failure to communicate with the first wide-area wireless access network. Detecting the hard failure may comprise detecting at least one of a context mismatch between user equipment and the first wireless network, an incorrectly functioning 1x circuit switched interworking solution, and access to the first radio access technology is barred by the first wireless network.

In an implementation, the method may further comprise determining that the first threshold has been exceeded by maintaining a re-try counter. In another implementation, determining that the first threshold has been exceeded may further comprise maintaining a re-try timer.

In an example, performing the attempt may comprise determining that either the first threshold for the re-try counter or a second threshold for the re-try timer has been exceeded for attempting to re-acquire and re-dial the voice call via the first radio access technology. In another example, performing the attempt may comprise limiting a radio link failure acquisition scan of the first radio access technology by scanning a bandwidth of the first radio access technology once. In another example, performing the attempt may comprise limiting a radio link failure acquisition scan of the first radio access technology by scanning the first radio access technology comprising Long Term Evolution (LTE) and not scanning a third radio access technology. In another example, performing the attempt may comprise limiting a radio link failure acquisition scan of the first radio access technology by receiving a reduced time value from a network in response to the network detecting that an unconnected 1x circuit switched fallback is being performed rather than a data call. In another example, performing the attempt may comprise limiting a radio link failure acquisition scan of the first radio access technology by determining the portion of the bandwidth at user equipment and scanning the portion once.

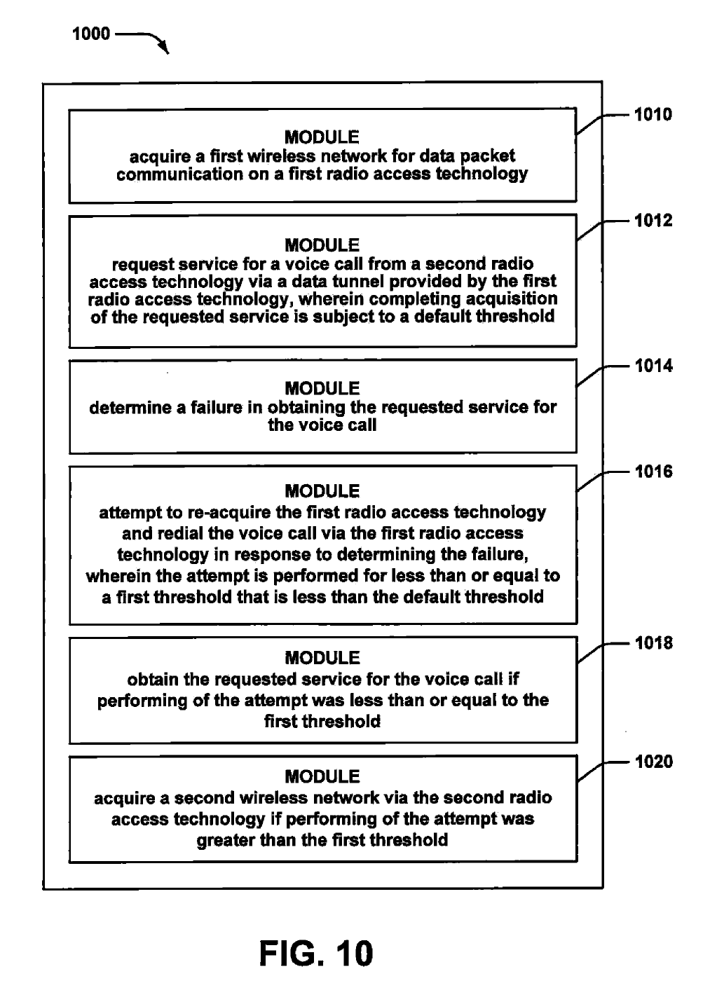

FIG. 10 shows a diagram 1000 illustrating an embodiment of functionality of an apparatus (e.g., the apparatus 800 of FIG. 8) configured to facilitate wireless communication, in accordance with aspects of the disclosure.

Referring to FIG. 10, the apparatus includes a module 1010 configured to acquire a first wireless network for data packet communication on a first radio access technology. The apparatus includes a module 1012 configured to request service for a voice call from a second radio access technology via a data tunnel provided by the first radio access technology, wherein completing acquisition of the requested service is subject to a default threshold. The apparatus includes a module 1014 configured to determine a failure in obtaining the requested service for the voice call. The apparatus includes a module 1016 configured to attempt to re-acquire the first radio access technology and redial the voice call via the first radio access technology in response to determining the failure, wherein the attempt is performed for less than or equal to a first threshold that is less than the default threshold. The apparatus includes a module 1018 configured to obtain the requested service for the voice call if performing of the attempt was less than or equal to the first threshold. The apparatus includes a module 1020 configured to acquire a second wireless network via the second radio access technology if performing of the attempt was greater than the first threshold. In various implementations, the apparatus may include additional modules that perform each step in the aforementioned flow charts. As such, each step in the aforementioned flow charts may be performed by a module, and the apparatus may include one or more of those modules.

Referring to FIG. 8, in a configuration, the apparatus 800 configured for wireless communication comprises the processing system 806 configured to provide means for acquiring a first wireless network for data packet communication on a first radio access technology, means for requesting service for a voice call from a second radio access technology via a data tunnel provided by the first radio access technology, wherein completing acquisition of the requested service is subject to a default threshold, means for determining a failure in obtaining the requested service for the voice call, means for attempting to re-acquire the first radio access technology and redial the voice call via the first radio access technology in response to determining the failure, wherein the attempt is performed for less than or equal to a first threshold that is less than the default threshold, means for obtaining the requested service for the voice call if performing of the attempt was less than or equal to the first threshold, and means for acquiring a second wireless network via the second radio access technology if performing of the attempt was greater than the first threshold. In various implementations, the apparatus 800 may include additional means for performing each step in the aforementioned flow charts. As such, each step in the aforementioned flow charts may be performed by the processing system 806, and the apparatus 800 may include one or more of those means.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution and a component may be localized on one computer and/or distributed between two or more computers. In addition, these components may execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Further, various aspects are described herein in connection with a terminal, which may be a wired terminal or a wireless terminal. A terminal may be referred to as a system, device, subscriber unit, subscriber station, mobile station, mobile, mobile device, remote station, remote terminal, access terminal, user terminal, terminal, communication device, user agent, user device, or UE. A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminals) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

In accordance with aspects of the disclosure, the techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. It is also to be understood and appreciated that a combination of these approaches may be used.

It is to be further understood and appreciated that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in. execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

In accordance with aspects of the disclosure, the word “exemplary” is used herein to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein may be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. In an implementation, a processor may also be implemented as a combination of computing devices, e.g., a combination of a DSP and a microprocessor, a plurality of microprocessors, one or more microprocessors in conjunction with a DSP core, or any other such configuration. In another implementation, at least one processor may comprise one or more modules operable to perform one or more of the steps and/or actions described above.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media may include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave may be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

In accordance with aspects of the disclosure, the steps and/or actions of the one or more methods and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor may read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects of the disclosure, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for wireless communication, comprising:
acquiring a first wireless network for data packet communication on a first radio access technology;
requesting service for a voice call from a second radio access technology via a data tunnel provided by the first radio access technology, wherein completing acquisition of the requested service is subject to a default threshold;
determining a failure in obtaining the requested service for the voice call;
attempting to re-acquire the first radio access technology and redial the voice call via the first radio access technology in response to determining the failure, wherein the attempt is performed for less than or equal to a first threshold that is less than the default threshold;
obtaining the requested service for the voice call if performing of the attempt was less than or equal to the first threshold; and
acquiring a second wireless network via the second radio access technology if performing of the attempt was greater than the first threshold.

2. The method of claim 1, wherein:
the first wireless network comprises a first wide-area access network, and
the first radio access technology comprises Long Term Evolution (LTE).

3. The method of claim 1, wherein:
the second wireless network comprises a second wide-area access network, and
the second radio access technology comprises 1x Radio Transmission Technology (RTT).

4. The method of claim 1, wherein the voice call comprises a mobile-originated voice call or mobile terminated voice call.

5. The method of claim 1, wherein the failure comprises a radio link failure.

6. The method of claim 1, further comprising acquiring the second wireless network via the second radio access technology in response to detecting the failure as a hard failure to communicate with the first wide-area wireless access network.

7. The method of claim 6, wherein detecting the hard failure comprises detecting at least one of a context mismatch between user equipment and the first wireless network, an incorrectly functioning 1x circuit switched interworking solution, and access to the first radio access technology is barred by the first wireless network.

8. The method of claim 1, further comprising determining that the first threshold has been exceeded by maintaining a re-try counter.

9. The method of claim 1, wherein determining that the first threshold has been exceeded further comprises maintaining a re-try timer.

10. The method of claim 9, wherein performing the attempt further comprises determining that either the first threshold for the re-try counter or a second threshold for the re-try timer has been exceeded for attempting to re-acquire and re-dial the voice call via the first radio access technology.

11. The method of claim 1, wherein performing the attempt further comprises limiting a radio link failure acquisition scan of the first radio access technology by scanning a bandwidth of the first radio access technology once.

12. The method of claim 1, wherein performing the attempt further comprises limiting a radio link failure acquisition scan of the first radio access technology by scanning the first radio access technology comprising Long Term Evolution (LTE) and not scanning a third radio access technology.

13. The method of claim 1, wherein performing the attempt further comprises limiting a radio link failure acquisition scan of the first radio access technology by receiving a reduced time value from a network in response to the network detecting that an unconnected 1x circuit switched fallback is being performed rather than a data call.

14. The method of claim 1, wherein performing the attempt further comprises limiting a radio link failure acquisition scan of the first radio access technology by determining the portion of the bandwidth at user equipment and scanning the portion once.

15. An apparatus for wireless communication, comprising:
a processing system configured to:
acquire a first wireless network for data packet communication on a first radio access technology;
request service for a voice call from a second radio access technology via a data tunnel provided by the first radio access technology, wherein completing acquisition of the requested service is subject to a default threshold;
determine a failure in obtaining the requested service for the voice call;
attempt to re-acquire the first radio access technology and redial the voice call via the first radio access technology in response to determining the failure, wherein the attempt is performed for less than or equal to a first threshold that is less than the default threshold;
obtain the requested service for the voice call if performing of the attempt was less than or equal to the first threshold; and
acquire a second wireless network via the second radio access technology if performing of the attempt was greater than the first threshold.

16. The apparatus of claim 15, wherein:
the first wireless network comprises a first wide-area access network, and
the first radio access technology comprises Long Term Evolution (LTE).

17. The apparatus of claim 15, wherein:
the second wireless network comprises a second wide-area access network, and
the second radio access technology comprises 1x Radio Transmission Technology (RTT).

18. The apparatus of claim 15, wherein the voice call comprises a mobile-originated voice call or mobile terminated voice call.

19. The apparatus of claim 15, wherein the failure comprises a radio link failure.

20. The apparatus of claim 15, wherein the processing system is further configured to acquire the second wireless network via the second radio access technology in response to detecting the failure as a hard failure to communicate with the first wide-area wireless access network.

21. The apparatus of claim 20, wherein detecting the hard failure comprises detecting at least one of a context mismatch between user equipment and the first wireless network, an incorrectly functioning 1x circuit switched interworking solution, and access to the first radio access technology is barred by the first wireless network.

22. The apparatus of claim 15, wherein the processing system is further configured to determine that the first threshold has been exceeded by maintaining a re-try counter.

23. The apparatus of claim 15, wherein determining that the first threshold has been exceeded further comprises maintaining a re-try timer.

24. The apparatus of claim 23, wherein performing the attempt further comprises determining that either the first threshold for the re-try counter or a second threshold for the re-try timer has been exceeded for attempting to re-acquire and re-dial the voice call via the first radio access technology.

25. The apparatus of claim 15, wherein performing the attempt further comprises limiting a radio link failure acquisition scan of the first radio access technology by scanning a bandwidth of the first radio access technology once.

26. The apparatus of claim 15, wherein performing the attempt further comprises limiting a radio link failure acquisition scan of the first radio access technology by scanning the first radio access technology comprising Long Term Evolution (LTE) and not scanning a third radio access technology.

27. The apparatus of claim 15, wherein performing the attempt further comprises limiting a radio link failure acquisition scan of the first radio access technology by receiving a reduced time value from a network in response to the network detecting that an unconnected 1x circuit switched fallback is being performed rather than a data call.

28. The apparatus of claim 15, wherein performing the attempt further comprises limiting a radio link failure acquisition scan of the first radio access technology by determining the portion of the bandwidth at user equipment and scanning the portion once.

29. An apparatus for wireless communication, comprising:
means for acquiring a first wireless network for data packet communication on a first radio access technology;
means for requesting service for a voice call from a second radio access technology via a data tunnel provided by the first radio access technology, wherein completing acquisition of the requested service is subject to a default threshold;
means for determining a failure in obtaining the requested service for the voice call;
means for attempting to re-acquire the first radio access technology and redial the voice call via the first radio access technology in response to determining the failure, wherein the attempt is performed for less than or equal to a first threshold that is less than the default threshold;
means for obtaining the requested service for the voice call if performing of the attempt was less than or equal to the first threshold; and
means for acquiring a second wireless network via the second radio access technology if performing of the attempt was greater than the first threshold.

30. The apparatus of claim 29, wherein:
the first wireless network comprises a first wide-area access network, and
the first radio access technology comprises Long Term Evolution (LTE).

31. The apparatus of claim 29, wherein:
the second wireless network comprises a second wide-area access network, and
the second radio access technology comprises 1x Radio Transmission Technology (RTT).

32. The apparatus of claim 29, wherein the voice call comprises a mobile-originated voice call or mobile terminated voice call.

33. The apparatus of claim 29, wherein the failure comprises a radio link failure.

34. The apparatus of claim 29, further comprising means for acquiring the second wireless network via the second radio access technology in response to detecting the failure as a hard failure to communicate with the first wide-area wireless access network.

35. The apparatus of claim 34, wherein the means for detecting the hard failure further comprises means for detecting at least one of a context mismatch between user equipment and the first wireless network, an incorrectly functioning 1x circuit switched interworking solution, and access to the first radio access technology is barred by the first wireless network.

36. The apparatus of claim 29, further comprising means for determining that the first threshold has been exceeded by maintaining a re-try counter.

37. The apparatus of claim 29, wherein the means for determining that the first threshold has been exceeded further comprises means for maintaining a re-try timer.

38. The apparatus of claim 37, wherein the means for performing the attempt further comprises means for determining that either the first threshold for the re-try counter or a second threshold for the re-try timer has been exceeded for attempting to re-acquire and re-dial the voice call via the first radio access technology.

39. The apparatus of claim 29, wherein the means for performing the attempt further comprises means for limiting a radio link failure acquisition scan of the first radio access technology by scanning a bandwidth of the first radio access technology once.

40. The apparatus of claim 29, wherein the means for performing the attempt further comprises means for limiting a radio link failure acquisition scan of the first radio access technology by scanning the first radio access technology comprising Long Term Evolution (LTE) and not scanning a third radio access technology.

41. The apparatus of claim 29, wherein the means for performing the attempt further comprises means for limiting a radio link failure acquisition scan of the first radio access technology by receiving a reduced time value from a network in response to the network detecting that an unconnected 1x circuit switched fallback is being performed rather than a data call.

42. The apparatus of claim 29, wherein the means for performing the attempt further comprises means for limiting a radio link failure acquisition scan of the first radio access technology by determining the portion of the bandwidth at user equipment and scanning the portion once.

43. A computer program product, comprising:
a computer-readable medium comprising code executable to cause an apparatus to:
acquire a first wireless network for data packet communication on a first radio access technology;
request service for a voice call from a second radio access technology via a data tunnel provided by the first radio access technology, wherein completing acquisition of the requested service is subject to a default threshold;
determine a failure in obtaining the requested service for the voice call;
attempt to re-acquire the first radio access technology and redial the voice call via the first radio access technology in response to determining the failure, wherein the attempt is performed for less than or equal to a first threshold that is less than the default threshold;
obtain the requested service for the voice call if performing of the attempt was less than or equal to the first threshold; and
acquire a second wireless network via the second radio access technology if performing of the attempt was greater than the first threshold.

44. The computer program product of claim 43, wherein:
the first wireless network comprises a first wide-area access network, and
the first radio access technology comprises Long Term Evolution (LTE).

45. The computer program product of claim 43, wherein:
the second wireless network comprises a second wide-area access network, and
the second radio access technology comprises 1x Radio Transmission Technology (RTT).

46. The computer program product of claim 43, wherein the voice call comprises a mobile-originated voice call or mobile terminated voice call.

47. The computer program product of claim 43, wherein the failure comprises a radio link failure.

48. The computer program product of claim 43, wherein the computer-readable medium further comprises code executable to cause the apparatus to acquire the second wireless network via the second radio access technology in response to detecting the failure as a hard failure to communicate with the first wide-area wireless access network.

49. The computer program product of claim 48, wherein detecting the hard failure comprises detecting at least one of a context mismatch between user equipment and the first wireless network, an incorrectly functioning 1x circuit switched interworking solution, and access to the first radio access technology is barred by the first wireless network.

50. The computer program product of claim 43, wherein the computer-readable medium further comprises code executable to cause the apparatus to determine that the first threshold has been exceeded by maintaining a re-try counter.

51. The computer program product of claim 43, wherein determining that the first threshold has been exceeded further comprises maintaining a re-try timer.

52. The computer program product of claim 51, wherein performing the attempt further comprises determining that either the first threshold for the re-try counter or a second threshold for the re-try timer has been exceeded for attempting to re-acquire and re-dial the voice call via the first radio access technology.

53. The computer program product of claim 43, wherein performing the attempt further comprises limiting a radio link failure acquisition scan of the first radio access technology by scanning a bandwidth of the first radio access technology once.

54. The computer program product of claim 43, wherein performing the attempt further comprises limiting a radio link failure acquisition scan of the first radio access technology by scanning the first radio access technology comprising Long Term Evolution (LTE) and not scanning a third radio access technology.

55. The computer program product of claim 43, wherein performing the attempt further comprises limiting a radio link failure acquisition scan of the first radio access technology by receiving a reduced time value from a network in response to the network detecting that an unconnected 1x circuit switched fallback is being performed rather than a data call.

56. The computer program product of claim 43, wherein performing the attempt further comprises limiting a radio link failure acquisition scan of the first radio access technology by determining the portion of the bandwidth at user equipment and scanning the portion once.
